(19) United States
(12) Patent Application Publication
(10) Pub. No.: US 2015/0168722 A1
(43) Pub. Date: Jun. 18, 2015

(54) APPARATUS AND METHOD FOR CONTROLLING POSITION OF DISPLAY IN WEARABLE DEVICE

(71) Applicant: SAMSUNG ELECTRO-MECHANICS CO., LTD., Suwon-Si (KR)

(72) Inventors: Sang Do Cho, Suwon-Si (KR); Peter Jean Woo Lim, Suwon-Si (KR); Je Ho Lee, Suwon-Si (KR)

(73) Assignee: SAMSUNG ELECTRO-MECHANICS CO., LTD., Suwon-Si (KR)

(21) Appl. No.: 14/326,396

(22) Filed: Jul. 8, 2014

(30) Foreign Application Priority Data
Dec. 18, 2013 (KR) 10-2013-0158250

(51) Int. Cl. G02B 27/01; G06F 3/01

(52) U.S. Cl. CPC G02B 27/017; G06F 3/01

(57) ABSTRACT

Disclosed herein is an apparatus for controlling a position of a display in a wearable device, including: a display module having the display movably mounted therein; and a movement compensating unit controlling a position of the display depending on movement of a user. Therefore, a smooth image compensation effect may be obtained, the user may accurately confirm contents displayed on the display, a focus of a line of sight of the user viewing the display may be fixed to one place, and fatigue of the user may be decreased to expand a use environment of the wearable device.

### CROSS REFERENCE TO RELATED APPLICATION

This application claims the benefit of Korean Patent Application No. 10-2013-0158250, filed on Dec. 18, 2013, entitled “Apparatus and Method for Controlling Position of Display in Wearable Device”, which is hereby incorporated by reference in its entirety into this application.

### BACKGROUND OF THE INVENTION

1. Technical Field

The present invention relates to an apparatus and a method for controlling a position of a display included in a wearable device, and more particularly, to an apparatus and a method for controlling a position of a display in a wearable device capable of controlling the position of the display based on movement of a user.

2. Description of the Related Art

In accordance with rapid spread of a smart phone, wearable computing has been spotlighted, and a representative device such as a Google Glass, a smart watch, or the like, has been manufactured as a product in the market. An example of a main technology for realizing convenience of the wearable device includes an audio interface, a high capacity small battery, a display that may be clearly viewed outside, and the like.

Among them, the display, which is a main component providing a feedback of information to a user in real time, has been miniaturized and mainly displays a text. Therefore, when considering that the user uses the display while moving, active compensation for vibrations of the display mounted in the wearable device depending on the movement of the user has been required.

FIG. 4 is a view showing a change in letters on a display in a stop state, which is a vibrationless state, and a moving state, which is a vibration state. As described in FIG. 4, in the case in which the user is moved, the display mounted in the wearable device is shaken, such that letters displayed on the display are shaken.

When the user tracks a change in positions of the letters displayed on the display in real time, it is less inconvenient to horizontally track the change in the letters due to a structure of eyes. However, when the change in the letters is vertically tracked, significant fatigue is caused. As the eyes of the user make an effort to continuously track the displayed letters, the fatigue of the user is increased to cause inconvenience.

The following Prior Art Document (Patent Document) has disclosed an apparatus and a method for processing an image capable of acquiring an image of which optical axes coincide with each other by image processing and rotation and parallel translation components are corrected based on an change amount in a viewing angle of a camera that may be acquired by an angular velocity sensor, or the like, without using a mechanism for controlling an optical axis of the camera. According to the following Patent Document, a variation in a viewing angle or blurring of an image due to movement of a wearer of a wearable camera may be decreased without a mechanism controlling an imaging device. However, in the apparatus and a method for processing an image disclosed in the following Patent Document, since an image signal is processed to thereby be corrected, it is difficult to obtain a smooth image compensation effect.

### PRIOR ART DOCUMENT

### Patent Document

(Patent Document 1) JP2007-228154 A

### SUMMARY OF THE INVENTION

The present invention has been made in an effort to provide an apparatus for controlling a position of a display in a wearable device capable of obtaining a smooth image compensation effect, allowing a user to accurately confirm contents displayed on the display, fixing a focus of a line of sight of the user viewing the display to one place, and decreasing fatigue of the user to expand a use environment of the wearable device.

Further, the present invention has been made in an effort to provide a method for controlling a position of a display in a wearable device capable of obtaining a smooth image compensation effect, allowing a user to accurately confirm contents displayed on the display, fixing a focus of a line of sight of the user viewing the display to one place, and decreasing fatigue of the user to expand a use environment of the wearable device.

According to a preferred embodiment of the present invention, there is provided an apparatus for controlling a position of a display in a wearable device, including: a display module having the display movably mounted therein; and a movement compensating unit controlling a position of the display depending on movement of a user.

The movement compensating unit may move the display in an opposite direction to a direction in which the user is moved, depending on the movement of the user.

The movement compensating unit may include: a movement detecting unit detecting the movement of the user; and a position controlling unit controlling the position of the display based on an output of the movement detecting unit and an actual position of the display.

The position controlling unit may include: a control position calculator calculating a control position of the display based on the output of the movement detecting unit and an actual position value of the display output from Hall sensors of the display module; a control amount calculator calculating a control amount by which the display is to be moved based on an output of the control position calculator; and a driver providing driving signals for moving the display to the display module based on an output of the control amount calculator.

The display module may include: the display; a first frame in which the display is mounted so as to be horizontally movable; and a second frame in which the first frame is mounted so as to be vertically movable.

The second frame may be fixed to the wearable device.

The display may include one or more ball bearings guiding horizontal movement of the display within the first frame, and the first frame may include one or more ball bearings guiding vertical movement of the first frame within the second frame.

The first frame may include one or more actuators disposed at upper and lower sides thereof, respectively, in order to horizontally move the display, and the second frame may include one or more actuators disposed at left and right sides thereof, respectively, in order to vertically move the first frame.

The actuator may include a voice coil motor (VCM) or a piezoelectric motor.

The first and second frames may include one or more Hall sensors detecting a current position of the display, respectively.

The display and the first frame may include one or more permanent magnets mounted at positions corresponding to those of the VCMs, respectively.

The first and second frames may include one or more buffers, respectively, in order to prevent the display from being damaged due to excessive movement thereof.

According to another preferred embodiment of the present invention, there is provided a method for controlling a position of a display in a wearable device including a display module having the display movably mounted therein, including: detecting movement of a user; and controlling a position of the display based on the detected movement.

The controlling of the position of the display may include moving the display in an opposite direction to a direction in which the display module is moved, depending on the movement of the user.

The controlling of the position of the display may include: calculating a control position of the display based on the detected movement and an actual position of the display; calculating a control amount by which the display is to be moved based on the control position of the display; and providing driving signals for moving the display to the display module based on the control amount.

The display module may include: the display; a first frame in which the display is mounted so as to be horizontally movable; and a second frame in which the first frame is mounted so as to be vertically movable.

The second frame may be fixed to the wearable device.

The first frame may include one or more actuators disposed at upper and lower sides thereof, respectively, in order to horizontally move the display, and the second frame may include one or more actuators disposed at left and right sides thereof, respectively, in order to vertically move the first frame.

The actuator may include a VCM or a piezoelectric motor.

The first and second frames may include one or more Hall sensors detecting a current position of the display, respectively.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing an apparatus for controlling a position of a display in a wearable device according to a preferred embodiment of the present invention;

FIG. 2 is a detailed view of a display module shown in FIG. 1;

FIG. 3 is a flow chart of a method for controlling a position of a display in a wearable device according to a preferred embodiment of the present invention; and

FIG. 4 is a view showing a change in letters on a display in a stop state and a moving state.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

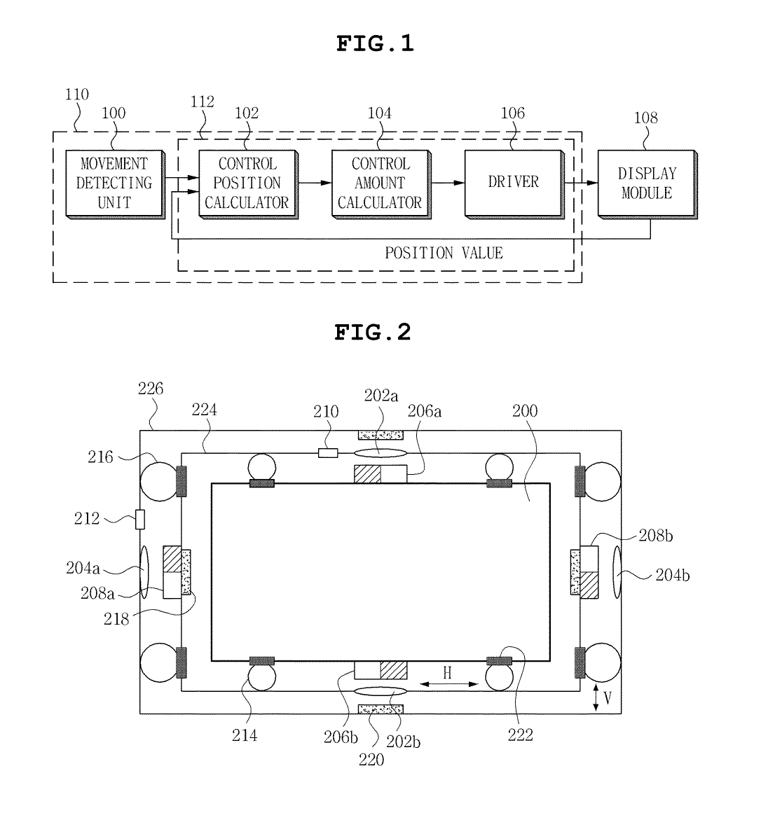

FIG. 1 is a block diagram showing an apparatus for controlling a position of a display in a wearable device according to a preferred embodiment of the present invention; and FIG. 2 is a detailed view of a display module shown in FIG. 1.

Hereinafter, an apparatus for controlling a position of a display in a wearable device according to a preferred embodiment of the present invention will be described with reference to FIGS. 1 and 2.

The apparatus for controlling a position of a display in a wearable device according to a preferred embodiment of the present invention shown in FIG. 1 is configured to include a display module 108 having a display 200 (See FIG. 2) movably mounted therein and a movement compensating unit 110 controlling a position of the display 200 depending on movement of a user.

The movement compensating unit 110 includes a movement detecting unit 100 detecting the movement of the user and a position controlling unit 112 controlling the position of the display 200 based on an output of the movement detecting unit 100 and an actual position of the display 200.

The position controlling unit 112 includes a control position calculator 102 calculating a control position of the display 200 based on the output of the movement detecting unit 100 and a current position value of the display 200 output from Hall sensors 210 and 212 (See FIG. 2) of the display module 108, a control amount calculator 104 calculating a control amount by which the display 200 is to be moved based on an output of the control position calculator 102, and a driver 106 providing driving signals for moving the display 200 to the display module 108 based on an output of the control amount calculator 104.

Meanwhile, the display module 108 shown in FIG. 2 includes the display 200, a first frame 224 in which the display 200 is mounted so as to be horizontally movable, and a second frame 226 in which the first frame 224 is mounted so as to be vertically movable. The second frame 226 is fixed to and mounted in the wearable device.

The display 200 includes four ball bearings 214 guiding horizontal movement of the display 200 within the first frame 224, and the first frame 224 includes four ball bearings 216 guiding vertical movement of the first frame 224 within the second frame 226. However, in a preferred embodiment of the present invention, the number of ball bearings is not limited thereto. The ball bearings 214 and 216 are fixed to the first frame 224 or the second frame 226 by bearing grippers 222 mounted thereon, respectively.

In addition, another component may be used instead of the ball bearing in order to guide the movement of the display 200 and the first frame 224.

The first frame 224 includes two voice coil motors (VCMs) 202a and 202b as actuators disposed at upper and lower sides thereof, respectively, in order to horizontally move the display 200, and the second frame 226 includes two VCMs 204a and 204b as actuators disposed at left and right sides thereof, respectively, in order to vertically move the first frame 224. Although the voice coil motors have been used as the actuators in a preferred embodiment of the present invention, the present invention is not limited thereto. That is, other actuators such as a piezoelectric motor may also be used.

In addition, the first and second frames 224 and 226 include the Hall sensors 210 and 212 detecting a current position of the display 200, respectively.

In addition, the display 200 and the first frame 224 include permanent magnets 206a, 206b, 208a, and 208b mounted at positions corresponding to those of the VCMs 202a, 202b, 204a, and 204b to generate Lorentz force, respectively.

In addition, the first and second frames 224 and 226 include buffers 218 and 220, respectively, in order to prevent the display 200 from being damaged due to excessive movement thereof.

An operation of the apparatus for controlling a position of a display in a wearable device according to a preferred embodiment of the present invention configured as described above will be described below with reference to FIGS. 1 and 2.

In the case in which the wearable device is moved due to movement of a user, the apparatus for controlling a position of a display in a wearable device according to a preferred embodiment of the present invention senses the movement of the user to actively move the display 200, thereby displaying an image in which shaking is minimized.

In the apparatus for controlling a position of a display in a wearable device according to a preferred embodiment of the present invention, the display is vertically and horizontally moved within a movement range determined based on the sensed movement of the user and a current position of the display, thereby displaying the image in which the shaking is minimized. Therefore, the user may accurately confirm contents displayed on the display and a focus of a line of sight of the user viewing the display may be fixed to one place, such that fatigue of the user may be decreased.

After the movement detecting unit 100 including a gyro sensor and an acceleration sensor first senses the movement of the user to detect movement information, the control position calculator 102 calculates the control position of the display 200 based on the output of the movement detecting unit 100 and an actual position value of the display 200 output from the Hall sensors 210 and 212 (See FIG. 2) of the display module 108.

The control amount calculator 104 calculates the control amount by which the display 200 is to be moved based on the output of the control position calculator 102, and the driver 106 provides the driving signals for moving the display 200 to the display module 108 based on the output of the control amount calculator 104.

The driving signals output from the driver 106 are applied to the VCMs 202a, 202b, 204a, and 204b (See FIG. 2) in the display module 108.

When the driving signal controlling the horizontal movement of the display 200 is applied to the VCMs 202a and 202b, Lorentz force is generated by an interaction between the VCMs 202a and 202b and the permanent magnets 206a and 206b, such that the display 200 in which the permanent magnets 206a and 206b are mounted is horizontally moved within the first frame 224 by the ball bearings 214.

In addition, when the driving signal controlling the vertical movement of the display 200 is applied to the VCMs 204a and 204b, Lorentz force is generated by an interaction between the VCMs 204a and 204b and the permanent magnets 208a and 208b, such that the first frame 224 in which the permanent magnets 208a and 208b are mounted is vertically moved within the second frame 226 by the ball bearings 216, thereby vertically moving the display 200.

According to a preferred embodiment of the present invention, in the case in which the user is moved, the display 200 is moved in, for example, an opposite direction to a direction in which the user is moved based on the movement of the user to compensate for the movement of the user, thereby making it possible to minimize shaking of an image display such as letters, or the like, displayed on the display 200.

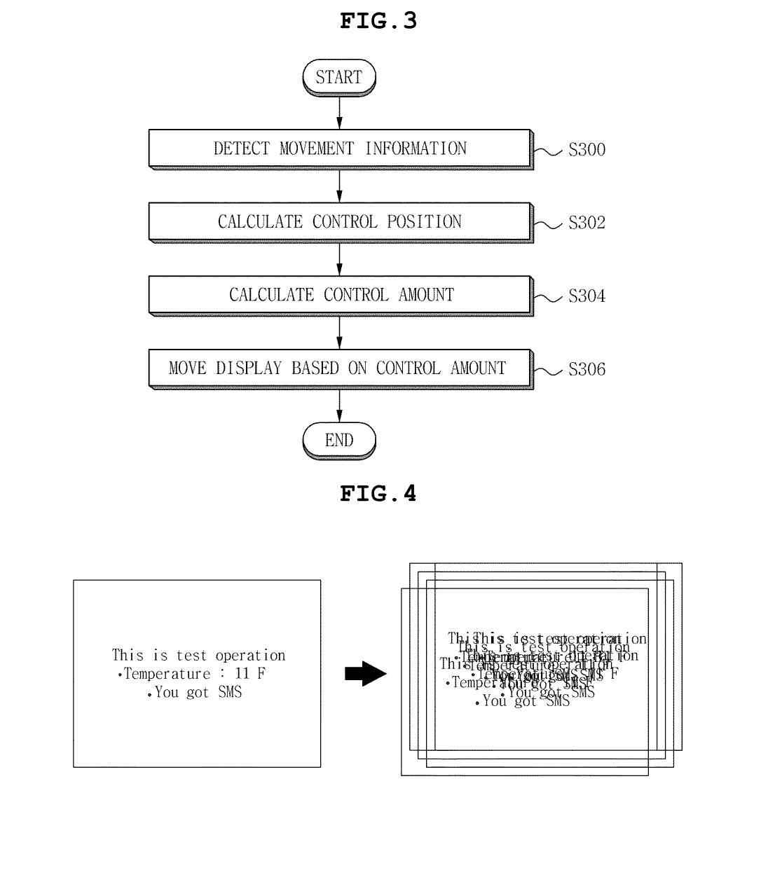

FIG. 3 is a flow chart of a method for controlling a position of a display in a wearable device according to a preferred embodiment of the present invention.

The method for controlling a position of a display in a wearable device according to a preferred embodiment of the present invention will be described with reference to FIG. 3.

In S300, the movement detecting unit 100 including the gyro sensor and the acceleration sensor senses the movement of the user to detect the movement information.

In S302, the control position calculator 102 calculates the control position of the display 200 based on the output of the movement detecting unit 100 and the actual position value of the display 200 output from the Hall sensors 210 and 212 (See FIG. 2) of the display module 108.

In S304, the control amount calculator 104 calculates the control amount by which the display 200 is to be moved based on the output of the control position calculator 102.

In S306, the driver 106 provides the driving signals for moving the display 200 to the display module 108 based on the output of the control amount calculator 104 to move the display 200 to a position at which the movement of the user is compensated for.

In S306, a process of moving the display 200 will be described below in detail.

The driving signals output from the driver 106 are applied to the VCMs 202a, 202b, 204a, and 204b (See FIG. 2) in the display module 108.

When the driving signal controlling the horizontal movement of the display 200 is applied to the VCMs 202a and 202b, Lorentz force is generated by an interaction between the VCMs 202a and 202b and the permanent magnets 206a and 206b, such that the display 200 in which the permanent magnets 206a and 206b are mounted is horizontally moved within the first frame 224 by the ball bearings 214.

In addition, when the driving signal controlling the vertical movement of the display 200 is applied to the VCMs 204a and 204b, Lorentz force is generated by an interaction between the VCMs 204a and 204b and the permanent magnets 208a and 208b, such that the first frame 224 in which the permanent magnets 208a and 208b are mounted is vertically moved within the second frame 226 by the ball bearings 216, thereby vertically moving the display 200.

Therefore, according to a preferred embodiment of the present invention, in the case in which the user is moved, the display 200 is moved in, for example, an opposite direction to a direction in which the user is moved based on the movement of the user to compensate for the movement of the user, thereby making it possible to minimize shaking of an image display such as letters, or the like, displayed on the display 200.

With the apparatus and the method for controlling a position of a display in a wearable device according to a preferred embodiment of the present invention, a smooth image compensation effect may be obtained at power lower as compared with a scheme of compensating for movement of the user through image signal processing, the user may accurately confirm contents displayed on the display, a focus of a line of sight of the user viewing the display may be fixed to one place, and fatigue of the user may be decreased to expand a use environment of the wearable device.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An apparatus for controlling a position of a display in a wearable device, comprising:
a display module having the display movably mounted therein; and
a movement compensating unit controlling a position of the display depending on movement of a user.

2. The apparatus for controlling a position of a display in a wearable device as set forth in claim 1, wherein the movement compensating unit moves the display in an opposite direction to a direction in which the user is moved, depending on the movement of the user.

3. The apparatus for controlling a position of a display in a wearable device as set forth in claim 1, wherein the movement compensating unit includes:
a movement detecting unit detecting the movement of the user; and
a position controlling unit controlling the position of the display based on an output of the movement detecting unit and an actual position of the display.

4. The apparatus for controlling a position of a display in a wearable device as set forth in claim 3, wherein the position controlling unit includes:
a control position calculator calculating a control position of the display based on the output of the movement detecting unit and an actual position value of the display output from Hall sensors of the display module;
a control amount calculator calculating a control amount by which the display is to be moved based on an output of the control position calculator; and
a driver providing driving signals for moving the display to the display module based on an output of the control amount calculator.

5. The apparatus for controlling a position of a display in a wearable device as set forth in claim 1, wherein the display module includes:
the display;
a first frame in which the display is mounted so as to be horizontally movable; and
a second frame in which the first frame is mounted so as to be vertically movable.

6. The apparatus for controlling a position of a display in a wearable device as set forth in claim 5, wherein the second frame is fixed to the wearable device.

7. The apparatus for controlling a position of a display in a wearable device as set forth in claim 5, wherein the display includes one or more ball bearings guiding horizontal movement of the display within the first frame, and
the first frame includes one or more ball bearings guiding vertical movement of the first frame within the second frame.

8. The apparatus for controlling a position of a display in a wearable device as set forth in claim 7, wherein the first frame includes one or more actuators disposed at upper and lower sides thereof, respectively, in order to horizontally move the display, and
the second frame includes one or more actuators disposed at left and right sides thereof, respectively, in order to vertically move the first frame.

9. The apparatus for controlling a position of a display in a wearable device as set forth in claim 8, wherein the actuator includes a voice coil motor (VCM) or a piezoelectric motor.

10. The apparatus for controlling a position of a display in a wearable device as set forth in claim 9, wherein the first and second frames include one or more Hall sensors detecting a current position of the display, respectively.

11. The apparatus for controlling a position of a display in a wearable device as set forth in claim 9, wherein the display and the first frame include one or more permanent magnets mounted at positions corresponding to those of the VCMs, respectively.

12. The apparatus for controlling a position of a display in a wearable device as set forth in claim 11, wherein the first and second frames include one or more buffers, respectively, in order to prevent the display from being damaged due to excessive movement thereof.

13. A method for controlling a position of a display in a wearable device including a display module having the display movably mounted therein, comprising:
detecting movement of a user; and
controlling a position of the display based on the detected movement.

14. The method for controlling a position of a display in a wearable device as set forth in claim 13, wherein the controlling of the position of the display includes moving the display in an opposite direction to a direction in which the display module is moved, depending on the movement of the user.

15. The method for controlling a position of a display in a wearable device as set forth in claim 13, wherein the controlling of the position of the display includes:
calculating a control position of the display based on the detected movement and an actual position of the display;
calculating a control amount by which the display is to be moved based on the control position of the display; and
providing driving signals for moving the display to the display module based on the control amount.

16. The method for controlling a position of a display in a wearable device as set forth in claim 13, wherein the display module includes:
the display;
a first frame in which the display is mounted so as to be horizontally movable; and
a second frame in which the first frame is mounted so as to be vertically movable.

17. The method for controlling a position of a display in a wearable device as set forth in claim 16, wherein the second frame is fixed to the wearable device.

18. The method for controlling a position of a display in a wearable device as set forth in claim 17, wherein the first frame includes one or more actuators disposed at upper and lower sides thereof, respectively, in order to horizontally move the display, and
the second frame includes one or more actuators disposed at left and right sides thereof, respectively, in order to vertically move the first frame.

19. The method for controlling a position of a display in a wearable device as set forth in claim 18, wherein the actuator includes a VCM or a piezoelectric motor.

20. The method for controlling a position of a display in a wearable device as set forth in claim 19, wherein the first and second frames include one or more Hall sensors detecting a current position of the display, respectively.
